(19) United States
(12) Patent Application Publication
(10) Pub. No.: US 2009/0213067 A1
(43) Pub. Date: Aug. 27, 2009

(54) INTERACTING WITH A COMPUTER VIA INTERACTION WITH A PROJECTED IMAGE

(75) Inventors: Lydia M. Do, Research Triangle Park, NC (US); Steven M. Miller, Cary, NC (US); Pamela A. Nesbitt, Tampa, FL (US); Lisa A. Seacat, San Francisco, CA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/035,428

(22) Filed: Feb. 21, 2008

(51) Int. Cl. G09G 5/00

(52) U.S. Cl. 345/156

(57) ABSTRACT

Embodiments of the present invention address deficiencies of the art in respect to user interfaces and provide a novel and non-obvious system for interacting with a computer via a projected image. In one embodiment of the invention, the system includes a projector for generating a projected image onto a surface, wherein the projected image corresponds to a first image on a display of the computer. The system further includes a sensor for sensing a human interaction with the projected image and generating a first information representing the human interaction and a transmitter for transmitting the first information to the computer. The system further includes a program on the computer that receives the first information and translates it into a second information representing a human interaction with the first image.

### BACKGROUND OF THE INVENTION

1. Field of the Invention

The present invention relates to user interfaces for computers, and more particularly to a remote user interface for a computer.

2. Description of the Related Art

The use of projectors during meetings and conferences is common. Projectors are used by individuals to project information from their device, such as a laptop computer, onto a surface such as a pull screen or a blank wall. The projected image is typically greater in size to the image displayed on the computer so that an audience can easily view the projected image.

During a presentation where a computer image is projected on a surface, the presenter usually points to and interacts with the projected image. As such, the projected image is used by the presenter as a method for connecting with the audience. Conventional systems for projecting computer images require that the presenter interact with the computer if he desires to manipulate the projected image. For example, if the presenter desires to advance the current slide or magnify the project image, the presenter is required to use a mouse or a touchpad on the computer to execute the desired action. In short, in order to manipulate the projected image, the presenter must manipulate the computer where the image originates. This results in the presenter taking his attention away from the projected image, which may distract the audience. Further, the presenter is forced to repeatedly view both the image on the computer and the projected image, which can be disconcerting and bothersome.

One common approach to this problem is a projector hookup embedded in a presentation stand or podium. This hookup connects a projector to a laptop computer of the presenter wherein the projector projects the image on the user's computer onto a screen. The drawback to this approach is that the presenter must look down at his computer while manipulating the projected image, which can be confusing.

Another approach to this problem includes the use of a wireless controller, such as a wireless mouse or wireless pointer. These devices allow a presenter to advance between slides or stop a presentation. However, these devices can't perform more advanced manipulations such as maximizing or minimize a window. Yet another approach to this problem includes the use of a team member to interact with the laptop computer while the presenter performs his presentation. The drawback to this approach is that the team member interacting with the laptop computer must rely on oral commands from the presenter that indicates how to manipulate the projected image, such as when to advance to the next slide. Further, this approach requires the presence of another person.

Therefore, there is a need to improve upon the processes of the prior art and more particularly for a more efficient way for interacting with a computer via interaction with a projected image.

### BRIEF SUMMARY OF THE INVENTION

Embodiments of the present invention address deficiencies of the art in respect to user interfaces and provide a novel and non-obvious system for interacting with a computer via a projected image. In one embodiment of the invention, the system includes a projector for generating a projected image onto a surface, wherein the projected image corresponds to a first image on a display of the computer. The system further includes a sensor for sensing a human interaction with the projected image and generating a first information representing the human interaction and a transmitter for transmitting the first information to the computer. The system further includes a program on the computer that receives the first information and translates it into a second information representing a human interaction with the first image.

In another embodiment of the invention, a system for interacting with a computer via a projected image is provided. The system includes a computer comprising a display for displaying an image and a projector connected to the computer for projecting the image onto a surface. The system further includes a sensor for sensing a location of contact of an object with the image that is projected onto the surface and for generating a first coordinate representing the location of contact. The system further includes a transmitter for transmitting the first coordinate to the computer and a program on the computer that receives the first coordinate and maps it into a second coordinate representing a location on the image on the display of the computer.

In another embodiment of the invention, a method for interacting with a computer via a projected image is provided. The method includes projecting onto a surface an image on a display of a computer and sensing a location of contact of an object with the image that is projected onto the surface. The method further includes generating a first coordinate representing the location of contact. The method further includes transmitting the first coordinate to the computer and receiving, by the computer, the first coordinate and mapping it into a second coordinate representing a location on the image on the display of the computer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating the various components of a system for interacting with a computer via a projected image, in accordance with one embodiment of the present invention.

### DETAILED DESCRIPTION OF THE INVENTION

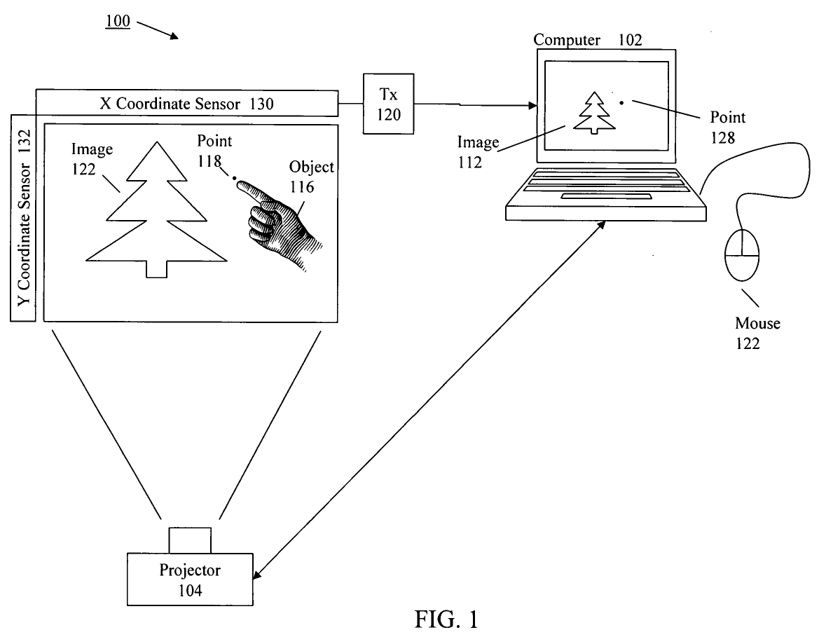

FIG. 1 is a block diagram illustrating the various components of a system 100 for interacting with a computer via a projected image, in accordance with one embodiment of the present invention. FIG. 1 includes a computer 102, such as a laptop computer, that includes a mouse 122 used by an individual so as to interact with the computer 102. An image 112 is displayed on the display or monitor of computer 102. Image 112 may be an image of a typical computer desktop, including windows/graphical user interfaces for interacting with computer programs and the various components of windows/graphical user interfaces, such as buttons, icons, sliders, pull down menus, and other interface widgets.

FIG. 1 further shows that the computer 102 is connected to the projector 104. Such a connection may be a wired connection, such as a VGA port connection, or a wireless connection, such as a Bluetooth or a Wi-Fi connection. In an alternative embodiment, the computer 102 is connected to the projector 104 via a data port such as a serial data port, a USB port or a FireWire port.

The computer 102 sends the image 112 to the projector 104, which in turn projects it as image 122 onto a surface, such as a wall or a projection screen. Image 122 may Note that image 122 may be a different size or ratio than image 112.

FIG. 1 further shows a first sensor 130 and a second sensor 132, which gather information pertaining to human interactions with the image 122. First sensor 130 is positioned horizontally to the image 122. The first sensor 130 is positioned such that it may capture the X-coordinate or the horizontal location of an object interacting with the image 122. FIG. 1 further shows a second sensor 132 that is positioned vertically to the image 122. The second sensor 132 is positioned such that it may capture the Y-coordinate or the vertical location of an object interacting with the image 122. Each sensor is able to sense contact of the image 122 with an external object such as a pen, a person's hand, a pointer or a ruler.

In one embodiment of the present invention, the first sensor 130 and second sensor 132 each comprise an array of light (such as infrared or visible light) sensors that detect the interruption of a modulated light beam when an object enters the path of the light beam. In another embodiment of the present invention, the first sensor 130 and second sensor 132 each comprise an array of acoustic wave sensors that detect the interruption or interference with an acoustic wave when an object enters the path of the acoustic wave.

In another embodiment of the present invention, a touch panel is used in lieu of the first sensor 130 and second sensor 132. In this embodiment, the touch panel can be any one of a resistive touch panel, a surface acoustic wave touch panel, a capacitive touch panel, strain gauge, dispersive signal technology touch panel, an acoustic pulse recognition touch panel, or a frustrated total internal reflection touch panel.

Upon sensing contact of an object, such as a person's hand 116, with the image 122, the sensors 130, 132 determine the location of contact of the object 116 with the image 122. FIG. 1 shows that the person's hand 116 contacted the image 122 at point 118. The sensors 130, 132 may generate and store a coordinate having two values—an x-coordinate and a y-coordinate. The x, y coordinates generated by the sensors 130, 132 determine the location of the point 118 in image 122. In an embodiment of the present invention, the x, y coordinates generated by the sensors 130, 132 correspond to a pixel coordinate wherein the x-coordinate corresponds to a number of pixels counted from the left to the right of the image 122 and the y-coordinate corresponds to a number of pixels counted from the top to the bottom of the image 122.

Upon sensing contact of an object with the image 122, the sensors 130, 132 may also determine and store the number of times the object 116 contacts the image 122 at point 118. Thus, the sensors 130, 132 may detect the occurrence of a tap, a double tap or a triple tap on the image 122 at point 118. Via detection of contact of an object 116 with the image 122, as well as detection of tapping on the image 122, the sensors 130, 132 may also determine and store the occurrence of dragging of an object 116 over the image 122.

Subsequent to the capture of information pertaining to human interactions with the image 122 (such as an x, y coordinate), the sensors 130, 132 transmit the information to the computer 102 using transmitter 120. In one embodiment of the present invention, the transmitter 120 sends the information to the computer 102 via a wired connection, such over a serial data port, a USB port or a FireWire port. In another embodiment of the present invention, the transmitter 120 sends the information to the computer 102 via a wireless connection, such as a Bluetooth or a Wi-Fi connection.

In one embodiment of the present invention, the human interactions with the image 122 are captured by a device apart from the sensors 130, 132, such as a wireless mouse or a wireless pointer. In this embodiment, the device captures information pertaining to human interactions with the image 122 (such as an x, y coordinate), and subsequently transmits the information to the computer 102 using transmitter 120.

A computer program residing on computer 102 receives the information sent by the transmitter 120. The computer program proceeds to translate the information pertaining to human interactions with the image 122 to information pertaining to human interactions with the image 112. For example, if the computer program receives a double click at a point 118 in image 122, then the computer program must translate this human interaction into a double click at a corresponding point in the image 112. In another example, if the computer program receives a single click on a window in image 122, then the computer program must translate this human interaction into a single click at a corresponding window in the image 112.

With regard to translating the location of a point in image 122 to a point in image 112, the computer program translates a location in image 122 to a location in image 112 using a mapping algorithm. For example, if the computer program receives an x, y coordinate from the transmitter 120 (indicating that an object 116 has touched the image 122 at a point 118), the computer program maps the x, y coordinate from image 122 to image 112, resulting in the identification of a point 128 in image 112. Such a mapping may be a simple division of each coordinate by the factor by which the image 122 scales image 112. For example, if image 122 is twice as large as image 112 and the computer program receives a coordinate of 100, 50, then the computer program divides each coordinate by two, resulting in a mapped coordinate of 50, 25.

Subsequent to translating the information pertaining to human interactions with the image 122 to information pertaining to human interactions with the image 112, the computer program effectuates the human interaction onto the image 112. For example, if the computer program receives a single click for point 118 in image 122 and the computer program maps this information to a single click at point 128 in image 112, then the computer program places a mouse cursor at point 128 in image 112. In another example, if the computer program receives a double click on an icon at point 118 in image 122 and the computer program maps this information to a double click at an icon at point 128 in image 112, then the computer program double clicks the icon at point 128 in image 112.

The present invention provides advantages over the prior art as the system 100 allows a user to interact with the image 122 as if he were interacting directly with the image 112. The system 100 allows a user to utilize standard conventions for interacting with a graphical user interface, such as clicking, dragging and dropping, upon a projected image 122 using his hands or an object. Any interactions of the user with the image 122 are mirrored in the image 112 on the computer 102. This allows a user to concentrate solely on the image 122 during a presentation, keeping the attention of the audience on the user and/or the image 122. The user may manipulate the image 122, such as minimizing or maximizing the image, advance a slide and choose a slide from a list of selections.

In embodiments of the present invention, certain portions of the system 100 can take the form of an entirely hardware embodiment, an entirely software embodiment or an embodiment containing both hardware and software elements. In a preferred embodiment, certain portions of the system 100 are implemented in software, which includes but is not limited to firmware, resident software, microcode, and the like. Furthermore, certain portions of the system 100 can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code (such as described for computer 102) will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A system for interacting with a computer via a projected image, comprising:
a projector for generating a projected image onto a surface, wherein the projected image corresponds to a first image on a display of the computer;
a sensor for sensing a human interaction with the projected image and generating a first information representing the human interaction;
a transmitter for transmitting the first information to the computer; and
a program on the computer that receives the first information and translates it into a second information representing a human interaction with the first image.

2. The system of claim 1, wherein the projector is a digital video projector.

3. The system of claim 2, wherein the sensor comprises at least one light sensor that detects a location of contact of an object with the projected image.

4. The system of claim 3, wherein the sensor comprises a first light sensor situated horizontally with respect to the projected image so as to detect a horizontal location of contact of an object with the projected image; and a second light sensor situated vertically with respect to the projected image so as to detect a vertical location of contact of an object with the projected image.

5. The system of claim 4, wherein the first information comprises a coordinate identifying a location on the projected image that was contacted by an object.

6. The system of claim 5, wherein the first information comprises a number of times a location on the projected image was tapped by an object.

7. The system of claim 6, wherein the transmitter comprises a wireless transmitter.

8. The system of claim 6, wherein the second information comprises a coordinate identifying a location on the first image.

9. The system of claim 8, wherein the second information comprises a number of times a location on the first image shall be tapped.

10. The system of claim 8, wherein the program on the computer maps the first information to the second information using a mapping algorithm.

11. The system of claim 2, wherein the sensor comprises at least one acoustic sensor that detects a location of contact of an object with the projected image.

12. The system of claim 11, wherein the sensor comprises a first acoustic sensor situated horizontally with respect to the projected image so as to detect a horizontal location of contact of an object with the projected image; and a second acoustic sensor situated vertically with respect to the projected image so as to detect a vertical location of contact of an object with the projected image.

13. A system for interacting with a computer via a projected image, comprising:
a computer comprising a display for displaying an image;
a projector connected to the computer for projecting the image onto a surface;
a sensor for sensing a location of contact of an object with the image that is projected onto the surface and for generating a first coordinate representing the location of contact;
a transmitter for transmitting the first coordinate to the computer; and
a program on the computer that receives the first coordinate and maps it into a second coordinate representing a location on the image on the display of the computer.

14. The system of claim 13, further comprising:
a program on the computer that places a mouse cursor at the second coordinate in the image on the display of the computer.

15. The system of claim 14, wherein the sensor comprises at least one light sensor that detects a location of contact of an object with the image that is projected onto the surface.

16. The system of claim 15, wherein the sensor comprises a first light sensor situated horizontally with respect to the image that is projected onto the surface so as to detect a horizontal location of contact of an object with the image that is projected onto the surface; and a second light sensor situated vertically with respect to the image that is projected onto the surface so as to detect a vertical location of contact of an object with the image that is projected onto the surface.

17. A method for interacting with a computer via a projected image, comprising:
projecting onto a surface an image on a display of a computer;
sensing a location of contact of an object with the image that is projected onto the surface;
generating a first coordinate representing the location of contact;
transmitting the first coordinate to the computer; and
receiving, by the computer, the first coordinate and mapping it into a second coordinate representing a location on the image on the display of the computer.

18. The method of claim 17, further comprising:
placing, by the computer, a mouse cursor at the second coordinate in the image on the display of the computer.
